(19) United States
(12) Patent Application Publication
(10) Pub. No.: US 2019/0372852 A1
(43) Pub. Date: Dec. 5, 2019

(54) EVENT-AWARE DYNAMIC NETWORK CONTROL

(71) Applicant: NOBLIS, INC., Reston, VA (US)

(72) Inventors: Olga APARICIO, Herndon, VA (US); James R. SOLTYS, Reston, VA (US); Hugo BONUCCELLI, Fairfax Station, VA (US); Mohammed ZAATARI, McLean, VA (US)

(73) Assignee: NOBLIS, INC., Reston, VA (US)

(21) Appl. No.: 16/427,537

(22) Filed: May 31, 2019

Related U.S. Application Data
(60) Provisional application No. 62/680,266, filed on Jun. 4, 2018.

(51) Int. Cl. H04L 12/24; H04L 12/26

(52) U.S. Cl. CPC H04L 41/0896; H04L 43/0882

(57) ABSTRACT

Described are systems and methods for using a network-control application to dynamically reconfigure a Software Defined Networking (SDN) in response to detected internal or external events. The network-control application can receive, via an SDN controller, an operational status of the SDN network to determine whether a user-configured policy is applicable and should be applied on the SDN network. The network-control application can receive, via one or more data sources external to the SDN network, information including an event and a geographical indicator to determine whether a user-configured policy is applicable and should be applied on the SDN network. Once a policy is selected, the network-control application can be configured to generate and transmit a command to the SDN controller to cause the SDN controller to reconfigure the SDN network in accordance with the policy. Therefore, the SDN network may be preemptively reconfigured before severe degradation occurs.

### CROSS-REFERENCE TO RELATED APPLICATIONS

This application claims the benefit of U.S. Provisional Application No. 62/680,266, filed on Jun. 4, 2018, the entire contents of which is incorporated herein by reference and for all purposes.

### FIELD OF THE INVENTION

This disclosure relates generally to network infrastructure and, more specifically, to dynamically controlling configurations of the network infrastructure.

### BACKGROUND OF THE INVENTION

In traditional network infrastructure, a plurality of network nodes such as routers and switches include embedded routing algorithms for constructing efficient paths for routing network traffic across the network. Accordingly, the control plane and data plane for network traffic are integrated within each network node. This implementation results in complex and inefficient control of network traffic because each network node needs to be configured independently, which may not result in the most efficient path for packets across multiple nodes. Further, whenever the network infrastructure is physically altered (e.g., a network node being added, removed, or changed), one or more links between network nodes may need to be reconfigured on-site and each of the network nodes may also need to be independently reconfigured.

To address the inflexibility and complexity of traditional network infrastructures, Software Defined Networking (SDN) technologies have been developed. In an SDN network, an SDN controller can be introduced to the network to not only separate the control plane from the data-forwarding, but also centralize control of network traffic at the entire network level as opposed to at the level of the individual network nodes. In such networks, the SDN controller can be configured to determine a network configuration to be applied to the entire network. Then, the SDN controller may transmit the network configuration to one or more of the network nodes, which will each be programmed in near-real time to perform network traffic forwarding as dictated by the SDN controller. By separating the control plane from the data plane, the SDN controller enables a network administrator to quickly reconfigure many network nodes to fit his or her needs. Accordingly, the SDN controller may enable the SDN network to be easily scaled.

As easily configurable as SDN networks may be, SDN networks are still vulnerable to unexpected internal or external events in the network infrastructure. In particular, these internal or external events may not be detected until they cause severe network performance degradation. An example internal event may be a network node failure or a malicious attack on a network node that significantly increases utilized network bandwidth at that network node. Such internal events may severely disrupt network traffic in the SDN network and require the network administrator to both identify the internal event and manually reconfigure the SDN network through the SDN controller. An example external event may be a weather event that physically compromises power lines or other physical network infrastructure and renders one or more network nodes inoperable. As with the internal event, the network administrator may need to first identify the external event that disrupted the SDN network, and then reconfigure the SDN network through the SDN controller. In both the internal and external event examples, the SDN network may only be reactively reconfigured by the network administrator only after severe disruption to the SDN network has occurred or has been detected.

### SUMMARY OF THE INVENTION

As described above, there is a need for systems, methods, and techniques for reconfiguring Software Defined Networking (SDN) networks before such networks experience severe performance degradation caused by internal or external network disruptions. To address this need for an SDN network, a network-control application can be implemented to communicate with an SDN controller configured to control network-traffic routing and the forwarding functionality of nodes in the SDN network.

In some embodiments, to respond to internal events arising from within the SDN network, the network-control application may be configured to receive, via the SDN controller, an operational status of one or more network nodes in the SDN network. The network-control application can be configured to determine whether the operational status indicates the SDN network should be preemptively reconfigured before severe performance degradation occurs. In particular, the network-control application may retrieve a user-configured policy corresponding to the operational status and transmit a command to the SDN controller to cause the SDN controller to dynamically reconfigure the SDN network in accordance with the policy. Accordingly, the network-control application and SDN controller can cooperatively and dynamically reconfigure the SDN network in response to the operational status representing an internal event in the SDN network.

In some embodiments, to respond to external events arising from outside the SDN network, the network-control application may be configured to receive information from one or more data sources that are not associated with the plurality of nodes. The received information can include an event (e.g., a weather event) and a geographical indicator. Based on the received information, the network-control application may determine a network impact on one or more network nodes and whether the one or more network nodes should be reconfigured. In some embodiments, the network-control application may determine a network configuration that reduces the network impact on the one or more network nodes. Then, the network-control application may transmit a command to the SDN controller to cause the SDN controller to dynamically reconfigure the SDN network in accordance with the determined network configuration. Accordingly, the network-control application and SDN controller can cooperatively and dynamically reconfigure the SDN network in response to the information representing an external event on the SDN network.

In some embodiments, a method of dynamically reconfiguring a plurality of network nodes includes: receiving, at an application, via a northbound API of the SDN controller, an operational status of the plurality of network nodes from the SDN controller configured to monitor the plurality of network nodes; comparing the operational status with a plurality of stored conditions; determining that the operational status matches a first condition of the plurality of stored conditions; retrieving a user-configured policy corresponding to the first condition upon determining that the first condition has been matched, wherein the user-configured policy comprises an action to be executed on the plurality of network nodes; generating, based on the action, a command configured to be receivable and executable via the northbound API of the SDN controller; and transmitting the command to the SDN controller, wherein the command causes the SDN controller to reconfigure the plurality of network nodes in accordance with the action.

In some embodiments, to reconfigure the plurality of network nodes, the SDN controller is configured to transmit a plurality of requests to the plurality of network nodes, and the plurality of requests corresponds to the user-configured policy and comports with a southbound API of the SDN.

In some embodiments, the operational status is received in a format that comports with the northbound API of the SDN controller.

In some embodiments, receiving the network status includes: requesting the SDN controller to poll the plurality of network nodes for the network status at a user-configurable time interval.

In some embodiments, the operational status includes a traffic flow path bandwidth for a network node of the plurality of network nodes, a number of traffic flow paths at the network node, a traffic flow path bandwidth percentage spike at the network node, a security alert corresponding to the network node, or a response time of the network node.

In some embodiments, the plurality of stored conditions are set by a user.

In some embodiments, the method includes: receiving a default network status of the plurality of network nodes, wherein one or more of the plurality of conditions corresponds to the default network status.

In some embodiments, the user-configured policy includes instructions for: adjusting a bandwidth of one or more traffic flow paths of a network node of the plurality of network nodes. In some embodiments, the user-configured policy includes instructions for: deleting one or more traffic flow paths of a network node of the plurality of network nodes. In some embodiments, the user-configured policy includes instructions for: requesting the SDN controller to dynamically compute an alternate traffic flow path corresponding to a traffic flow path at a network node of the plurality of network nodes. In some embodiments, the user-configured policy includes instructions for: requesting the SDN controller to re-route network traffic to avoid a network node of the plurality of network nodes. In some embodiments, the user-configured policy includes instructions for: reconfiguring a management IP or a host name of a network node of the plurality of network nodes. In some embodiments, the user-configured policy includes instructions for: reconfiguring the plurality of network nodes according to a recovery state comprising a default network configuration. In some embodiments, the user-configured policy includes instructions for: disabling one or more ports of a network node of the plurality of network nodes.

In some embodiments, the method includes: receiving a second network status from a remote server; and comparing the second network status with the plurality of stored conditions to determine whether the second network status matches the first condition of the plurality of stored conditions.

In some embodiments, a method of dynamically reconfiguring a plurality of network nodes includes: receiving information from one or more data sources that are not associated with the plurality of network nodes, wherein the information comprises an event and a geographical indicator; querying a historical-events database based on the information to retrieve a network impact on a geographical area corresponding to the geographical indicator; receiving a plurality of network-configuration maps from a network-configurations database, wherein each network-configuration map comprises a network configuration for network nodes associated with the geographical area; selecting a network-configuration map from the plurality of network-configuration maps based on the network impact and the geographical area; and transmitting a command to a SDN controller to reconfigure the plurality of network nodes based on the selected network-configuration map.

In some embodiments, the one more data sources include a web server or a radio station.

In some embodiments, receiving the information includes: querying the information from a web server.

In some embodiments, the historical-events database is configured to store a plurality of events associated with each geographical area and to store a network impact corresponding to each association between an event and each geographical area.

In some embodiments, the event is a weather event and the information comprises a probability indicator for the weather event, and wherein the probability indicator comprises one or more of a percentage, a level, a watch, a warning, or an advisory.

In some embodiments, transmitting the message includes: generating the message to comport with a northbound application program interface (API) of the SDN controller, wherein the message represents the selected network-configuration map.

In some embodiments, selecting the network-configuration map includes: correlating the network impact and the geographical area to the plurality of network-configuration maps.

In some embodiments, correlating the network impact and the geographical area to the plurality of network-configuration maps includes: determining that the network-configuration map comprises a network configuration that negatively correlates to the network impact.

In some embodiments, the event includes high winds, a wildfire, a thunderstorm, a hurricane, a tornado, a flood, a cyclone, a waterspout, a blizzard, an ice storm, or a dust storm.

In some embodiments, the plurality of network nodes includes one or more of a hub, a bridge, a switch, a router, or a gate.

In some embodiments, a system for dynamically reconfiguring a plurality of network nodes includes one or more processors and memory storing one or more programs that when executed by the one or more processors cause the one or more processors to: receive, at an application, via a northbound API of the SDN controller, an operational status of the plurality of network nodes from the SDN controller configured to monitor the plurality of network nodes; compare the operational status with a plurality of stored conditions; determine that the operational status matches a first condition of the plurality of stored conditions; retrieve a user-configured policy corresponding to the first condition upon determining that the first condition has been matched, wherein the user-configured policy comprises an action to be executed on the plurality of network nodes; generate, based on the action, a command configured to be receivable and executable via the northbound API of the SDN controller; and transmit the command to the SDN controller, wherein the command causes the SDN controller to reconfigure the plurality of network nodes in accordance with the action.

In some embodiments, a system for dynamically reconfiguring a plurality of network nodes includes one or more processors and memory storing one or more programs that when executed by the one or more processors cause the one or more processors to: receive information from one or more data sources that are not associated with the plurality of network nodes, wherein the information comprises an event and a geographical indicator; query a historical-events database based on the information to retrieve a network impact on a geographical area corresponding to the geographical indicator; receive a plurality of network-configuration maps from a network-configurations database, wherein each network-configuration map comprises a network configuration for network nodes associated with the geographical area; select a network-configuration map from the plurality of network-configuration maps based on the network impact and the geographical area; and transmit a command to a Software Defined Networking (SDN) controller to reconfigure the plurality of network nodes based on the selected network-configuration map.

In some embodiments, a non-transitory computer-readable storage medium includes instructions for dynamically reconfiguring a plurality of network nodes, where the instructions, when executed by one or more processors, cause the one or more processors to perform instructions including: receiving, at an application, via a northbound API of the SDN controller, an operational status of the plurality of network nodes from the SDN controller configured to monitor the plurality of network nodes; comparing the operational status with a plurality of stored conditions; determining that the operational status matches a first condition of the plurality of stored conditions; retrieving a user-configured policy corresponding to the first condition upon determining that the first condition has been matched, wherein the user-configured policy comprises an action to be executed on the plurality of network nodes; generating, based on the action, a command configured to be receivable and executable via the northbound API of the SDN controller; and transmitting the command to the SDN controller, wherein the command causes the SDN controller to reconfigure the plurality of network nodes in accordance with the action.

In some embodiments, a non-transitory computer-readable storage medium includes instructions for dynamically reconfiguring a plurality of network nodes, where the instructions, when executed by one or more processors, cause the one or more processors to perform instructions including: receiving information from one or more data sources that are not associated with the plurality of network nodes, wherein the information comprises an event and a geographical indicator; querying a historical-events database based on the information to retrieve a network impact on a geographical area corresponding to the geographical indicator; receiving a plurality of network-configuration maps from a network-configurations database, wherein each network-configuration map comprises a network configuration for network nodes associated with the geographical area; selecting a network-configuration map from the plurality of network-configuration maps based on the network impact and the geographical area; and transmitting a command to a SDN controller to reconfigure the plurality of network nodes based on the selected network-configuration map.

### BRIEF DESCRIPTION OF THE DRAWINGS

The foregoing summary, as well as the following detailed description of embodiments, is better understood when read in conjunction with the appended drawings. For the purpose of illustrating the present disclosure, the drawings show example embodiments of the disclosure; the disclosure, however, is not limited to the specific methods and instrumentalities disclosed. In the drawings:

FIG. 1 illustrates a system for dynamically reconfiguring a plurality of network nodes in a Software Defined Networking (SDN) network, according to some embodiments;

FIG. 2 illustrates example data associations stored in a historical-events database used to respond to external events, according to some embodiments;

FIG. 3 illustrates a method for dynamically reconfiguring a plurality of network nodes, according to some embodiments;

FIG. 4 illustrates a method for dynamically reconfiguring a plurality of network nodes, according to some embodiments; and

FIG. 5 illustrates an example of a computing device in accordance with some embodiments.

### DETAILED DESCRIPTION OF THE INVENTION

As described above, there is a need for systems, methods, and techniques for reconfiguring SDN networks before such networks experience severe performance degradation. One solution to this need is to implement a network-control application that interfaces with an SDN controller configured to control network-traffic routing and the forwarding functionality of nodes in an SDN network.

In the systems and methods described herein, the network-control application can include a user interface that allows a user to store user-configured policies for responding to internal or external events. In some embodiments, the network-control application can receive, via the SDN controller, an operational status of the SDN network to determine whether a user-configured policy is applicable and should be applied on the SDN network. In some embodiments, the network-control application can receive, via one or more data sources external to the SDN network, information including an event and a geographical indicator to determine whether a user-configured policy is applicable and should be applied on the SDN network. Once a policy is selected, the network-control application can be configured to generate and transmit a command to the SDN controller to cause the SDN controller to reconfigure the SDN network in accordance with the policy. Therefore, the SDN network may be preemptively reconfigured before severe degradation occurs.

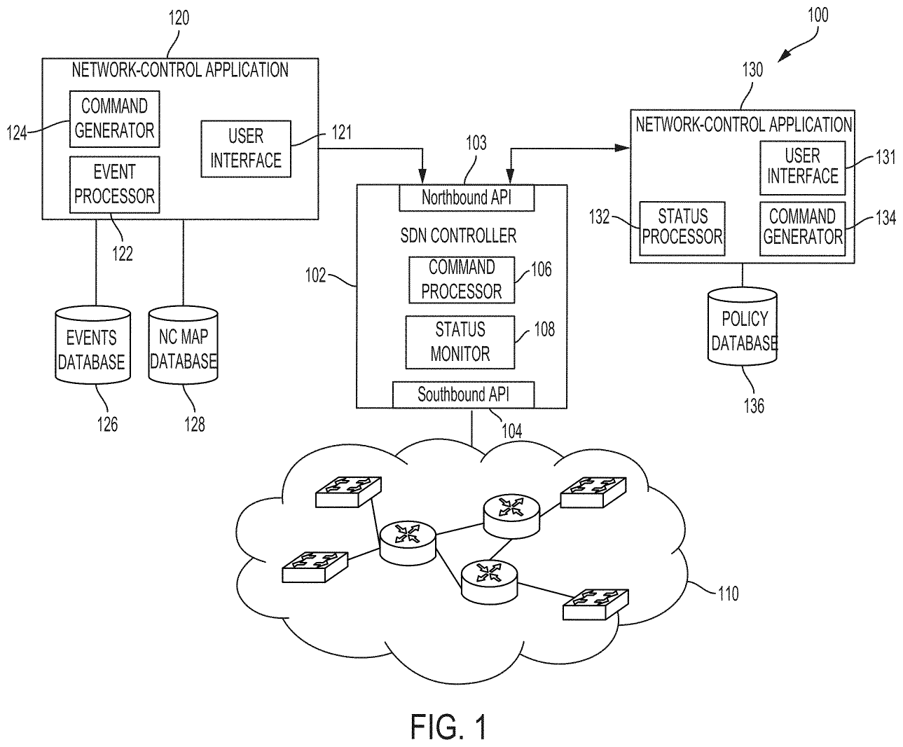

FIG. 1 illustrates a system 100 for dynamically reconfiguring a plurality of network nodes in a Software-Defined Networking (SDN) network 110, according to some embodiments. System 100 includes SDN controller 102 configured to control network-traffic routing and forwarding functionality of the plurality of network nodes in SDN network 110. Each of the network nodes in SDN network 110 can be configured to route or forward network traffic according to commands generated by SDN controller 102. In some embodiments, the plurality of network nodes may include one or more of a hub, a bridge, a switch, a router, or a gate. In some embodiments, SDN network 110 can include one or more of a local area network (LAN), a wide area network (WAN), a Wi-Fi network, a WiMAX network, a cellular network (e.g., 3G, 4G, 4G Long Term Evolution (LTE)), or a combination thereof.

In some embodiments, SDN controller 102 includes the following components: a northbound application program interface (API) 103, a southbound application program interface (API) 104, a status monitor 108, and a command processor 106. In some embodiments, each component can include a set of program instructions capable of being executed by SDN controller 102. SDN controller 102 can be implemented using on one or more of each of the following: a general-purpose computer, a virtual machine, a server, or a hardware appliance.

In some embodiments, southbound API 104 can be configured to define a set of message types capable of being exchanged between SDN controller 102 and the plurality of network nodes in SDN network 110. In some embodiments, southbound API 104 can be configured to query each of the network nodes to determine which types of messages each network node is capable of processing. In some embodiments, southbound API 104 may store the allowable message types for each network node in a network database. Further, southbound API 104 can be configured to transmit one or more of the defined set of messages to one or more network nodes in SDN network 110. In some embodiments, southbound API 104 implements one or more of the following protocols to transmit the messages: OpenFlow, PCEP, BGP, OSPF, ISIS, or P4. As a result, southbound API 104 can receive configuration and monitoring status from the plurality of network nodes in SDN network 110 to acquire a global visibility over the underlying network infrastructure (virtual or physical) and its characteristics to be processed by status monitor 108.

In some embodiments, the set of messages includes one or more commands executable by one or more network nodes to control the network configuration of SDN network 110. In some embodiments, the one or more commands relate to network-packet forwarding or routing functionality at a network node. For example, a command may be associated with adding, deleting, or editing one or more entries in a routing table stored at a network node. In another example, the one or more commands may be associated with configuring one or more parameters to select a traffic flow path in SDN network 110. For example, the traffic flow path may be a Label Switched Path (LSP).

In some embodiments, the one or more commands include a command to query one or more network nodes for an operational status query of SDN network 110. In some embodiments, the operational status includes one or more of a bandwidth for a link at a network node (e.g., a traffic flow bandwidth), a number of links at the network node (e.g., number of links to make a traffic flow), a bandwidth percentage spike at the network node (e.g., traffic flow bandwidth percentage spike), a security alert corresponding to the network node, a failure type at a network node, or a response time of the network node. In some embodiments, the security alert may indicate a vulnerability or abnormal behavior detected at a network node.

In some embodiments, status monitor 108 can be configured to poll SDN network 110 for the operational status by issuing one or more query commands through southbound API 104, as described above. In some embodiments, status monitor 108 can configure a polling interval that specifies when to issue the query commands. Status monitor 108 may set the polling interval based on user input received via one or more network-control applications 120 and 130. In some embodiments, status monitor 108 can be configured to poll SDN network 110 in response to a user command or a pre-defined trigger.

In some embodiments, northbound API 103 can be configured to define a set of message types capable of being exchanged between SDN controller 102 and one or more network-control applications 120 and 130. In some embodiments, northbound API 103 comports with the Representational State Transfer (REST) architectural style and implements a stateless protocol that enables reliable and fast messages to be exchanged between northbound API 103 and network-control applications 120 and 130. For example, northbound API 103 may communicate with one or more network-control applications 120 and 130 through JSON messages or XML messages. In some embodiments, northbound API 103 can be configured to transmit to network-control applications 120 and 130 the set of messages capable of being executed by one or more network nodes of SDN network 110, as determined and stored by southbound API 104 described above.

In some embodiments, command processor 106 can be configured to receive, from network-control application 120 or 130, a command related to reconfiguring SDN network 110. In some embodiments, the command is configured to be receivable and executable by SDN controller 102 via northbound API 103. In some embodiments, upon receipt of the command, command processor 106 can be configured to translate the command into a plurality of messages, as defined by southbound API 104, that are executable by one or more network nodes of SDN network 110. Then, command processor 106 may transmit the plurality of messages to SDN network 110 to reconfigure the plurality of nodes in accordance with the command received from network-control application 120 or 130. Accordingly, northbound API 103 enables SDN controller 102 to receive and parse precise actions generated by one or more of network-control applications 120 and 130 and the parse actions can be converted into network actions that are reported to SDN network 110 via outputs of southbound API 104.

In some embodiments, to enable dynamic and preemptive reconfiguration of the plurality of network nodes in SDN network 110, system 100 includes one or more network-control applications 120 and 130 capable of communicating with SDN controller 102. Each of network-control applications 120 and 130 may be implemented on one or more of a laptop, a mobile device, a server, a desktop, a virtual machine, and the like. In some embodiments, the functionality of network-control applications 120 and 130 can be implemented in a single network-control application.

In some embodiments, not only can network control applications 120 and 130 initiate actions to configure or reconfigure network behavior of SDN network 110, but also network control applications 120 and 130 can monitor and/or analyze quantifiable observations of SDN network 110 for reporting to users (e.g., network administrators), or trigger remedy actions for one or more network flows in response to detection of specific internal or external events. In some embodiments, each of network control applications 120 and 130 can initiate or trigger specific actions in SDN network 110 by issuing commands to SDN controller 102. For example, a command may be associated with adding, deleting, or editing one or more entries in a routing table stored at a network node of SDN network 110. In another example, the command may be associated with configuring one or more parameters of an established network flow path in SDN network 110. Another command issued by one of network-control applications 120 and 130 may be associated with making a change in the network configuration for selected network devices (e.g., specific network nodes in SDN network 110) in response to a triggering event. By reconfiguring the network for selected network devices, the change may apply only to affected devices for a traffic flow and avoids unnecessary changes to other flows that are not impacted by the triggering event.

In some embodiments, network control applications 120 and 130 can be configured to retrieve data (e.g., weather data) from one or more data sources to enable the detection of specific internal or external events. For example, network control application 120 may initiate on-demand data queries from a data source (e.g., a weather website) to retrieve specific data. Further, network control applications 120 and 130 can be configured to implement one or more analytics engines (e.g., Splunk or Hadoop) on the retrieved data, network status of SDN network 110, or a combination thereof to determine specific network configurations or actions to be processed by network nodes in SDN network 110. For example, when the external event is associated with specific weather events, network control applications 120 and 130 may correlate real-time weather data with a current state (e.g., received by status processor 132) of SDN network 110 to select specific configuration commands to be applied to SDN network 110 to respond to the detected external event.

In some embodiments, to enable dynamic reconfiguration of SDN network 110 in response to internal events, network-control application 130 includes the following components: status processor 132, command generator 134, and user interface 131.

In some embodiments, status processor 132 can be configured to monitor an operational status of SDN network 110 based on network polling performed by status monitor 108. In some embodiments, status processor 132 may transmit a message to SDN controller 102, via northbound API 103, that requests status monitor 108 to poll one or more network nodes of SDN network 110. In some embodiments, status processor 132 may transmit a message to SDN controller 102 that sets the polling interval of status monitor 108. In each of these embodiments, status processor 132 receives the operational status of SDN network 110 from SDN controller 102 through northbound API 103.

In some embodiments, status processor 132 can be configured to determine whether the operational status corresponds to a policy from a plurality of policies stored in policy database 136. The policy database can be implemented using an open-source or industry-standard distributed database management system. For example, the policy data stored in policy database 136 may be queried by means of an SQL-like language or (REST) APIs among others. Policy database 136 can be configured to import templates from open source or proprietary vendors depending on the types of network nodes deployed within SDN Network 110. In some embodiments, policy database 136 can be configured to store associations between conditions and corresponding actions to address the conditions. In some embodiments, each policy can be stored in policy database 136 as a policy profile that includes a condition and one or more associated actions to be executed on one or more network nodes in SDN network 110. The policies may be stored in a variety of formats such as in EXCEL sheets, proprietary data structures provided by a vendor, or database tables hosted by SDN controller 102.

In some embodiments, the condition can relate to a specific value or range of values of the operational status, as described above with respect to status monitor 108. For example, the condition may be a maximum bandwidth of a network link, a specific security alert type, a maximum number of network links at a network node, a maximum bandwidth percentage spike for a link, a maximum response time for a network link, a specific failure type, etc. In some embodiments, the policy profile can associate the condition with a file (e.g., a JSON file) storing one or more commands representative of the one or more actions to be taken on SDN network 110.

In some embodiments, each policy includes one or more actions associated with the condition to adjust one or more parameters of one or more network links in SDN network 110 to remedy the condition. For example, for SDN network 110 that implements Multi-Protocol Label Switching (MPLS), a plurality of label-switched paths (LSPs) are created for each pair of source and destination nodes that specifies the data path for a data packet to be routed between the source and destination nodes. For this type of SDN network 110, the table below shows example policies that may be stored:

| Example Condition | Example Action(s) |
|---|---|
| Bandwidth of a network path exceeds a | Reduce the allowed bandwidth for the network |
| threshold bandwidth | path; request reconfiguration of the network path; |
| | or delete the network path |
| A new network path is added with an | Reduce the allowed bandwidth for the network |
| allowable path bandwidth that exceeds a | path; request reconfiguration of the network path; |
| threshold path bandwidth | or delete the network path |
| A new network path results in a total | Delete the new network path; or request deletion |
| number of network paths that exceeds a | of at least one network path |
| maximum threshold number | |
| A bandwidth percentage spike for a | Throttle the bandwidth for the network path |
| network path exceeds a threshold | |
| percentage | |
| A security alert of a first network node | Reroute network traffic to avoid the first network |
| matches a first security alert type | node; reconfigure one or more parameters of the |
| | first network node; disable one or more ports of |
| | the first network node; rename a management IP |
| | or a host name of the first network node |

As shown in the table above, for each policy, one or more actions may be stored in association with a condition. For example, the one or more actions may be stored in a database table where each entry associates a condition with one or more corresponding actions. In some embodiments, a possible action includes initiating a software-based fast recovery process. For example, the software-based fast recovery process may include restoring SDN network to a default network configuration known to be safe and stable. Such an action may be desirable in response to detecting failure or malicious attacks across multiple network nodes.

In some embodiments, to determine whether the operational status corresponds to a policy, status processor 132 can be configured to compare the operational status with a plurality of stored conditions in policy database 136. For example, status processor 132 may query policy database 136 for a matching condition. In some embodiments, upon determining that the operational status matches a first condition from the plurality of conditions, status processor 132 can be configured to retrieve the policy that corresponds to the matched, first condition. As described above, the policy can include one or more actions to be executed on one or more nodes of the plurality of nodes in SDN network 110.

In some embodiments, command generator 134 generates a command to transmit to SDN controller 102 based on the action of the policy selected by status processor 132. In some embodiments, the command is configured to be receivable and executable via northbound API 103 of SDN controller 102. For example, command generator 134 may be configured to translate the action to one or more messages that comports with the allowable message types as defined by northbound API 103. Then, command generator 134 may transmit the one or more messages in the command transmitted to SDN controller 102.

In some embodiments, user interface 131 provides a web-based interface to enable a user to configure one or more of: a network monitoring frequency (e.g., a polling frequency or trigger condition(s)), types of operational statuses to be monitored, and policies to include in policy database 136. In some embodiments, user interface 131 provides the user with the types of operational statuses that can be monitored and the types of messages that southbound API 104 is configured to be capable of transmitting. Based on this information, user interface 131 can enable the user to configure specific policies that are triggered based on a received operational status matching a specific condition.

In some embodiments, to enable dynamic reconfiguration of SDN network 110 in response to external events, network-control application 120 includes the following components: event processor 122, command generator 124, and user interface 121.

In some embodiments, event processor 122 can be configured to receive information, corresponding to external events, from one or more data sources that are not associated with the plurality of network nodes of SDN network 110. In other words, the information may originate from “outside” SDN network 110. In some embodiments, the one or more data sources may include a radio station, a data server, a web server, wireless transmission, or a combination thereof.

In some embodiments, the information can indicate an event that is occurring, has occurred, or forecasted to occur independent of the operation of network nodes in SDN network 110. Accordingly, these events are external from SDN network 110 and SDN controller 102, but that may negatively impact network bandwidth of one or more network nodes in SDN network 110. For example, an event may be a weather event (e.g., a thunderstorm, a snowstorm, a wildfire, a hurricane, etc.) or a terrorist attack, each of which may disable physical infrastructure of SDN network 110 and cause network performance degradation. Another example of the event may be a construction project such as an excavation, which may disrupt one or more network nodes. In yet another example, the event may be a scheduled (e.g., a rolling blackout) or unscheduled power outage (e.g., brownout or blackout) that disables one or more network nodes of SDN network 110.

In some embodiments, the information includes the event and a geographical indicator associated with the event. For example, the geographical indicator may include a Global Positioning System (GPS) coordinate, a postal code, a state, a county, a city, etc. In some embodiments, the information includes a time period associated with the event. For example, if the information is weather information, the information may indicate a hurricane (e.g., an event) that is forecasted to impact Florida (e.g., a geographical indicator) next week (e.g., a time period). In some embodiments, wherein the information includes an event forecast, the information may include a probability indicator related to the probability of the event occurring. The probability indicator may be a percentage, a level, and the like. For example, for weather forecast information, the probability indicator may be any of the following indicators (listed in order of increased probability): watch, advisory, and warning.

In some embodiments, upon receiving the information, event processor 122 can be configured to determine a network impact associated with the event. In some embodiments, event processor 122 can be configured to query an events database 126 based on the information to retrieve information regarding the potential network impact on a geographical area corresponding to the geographical indicator in the information. In some embodiments, events database 126 can be configured to store associations between a network impact and a combination of one or more of an event, a geographical area, a time period, and a probability indicator. In some embodiments, events database 126 can store a network impact for every unique combination of the event, the geographical area, and the time period. In some embodiments, events database 126 can store a network impact for every unique combination of the event, the geographical area, the time period, and the probability indicator. In some embodiments, network-control application 120 can be configured to determine the associations to be stored in events database 126 based on historical data.

In some embodiments, network control applications 120 and 130 (e.g., command generators 124 and 134) can implement self-healing Artificial Intelligence (AI) models to predict the changes to SDN network 110 resulting from events (e.g., external or internal events) detected by one or both of network control applications 120 and 130. Accordingly, network control applications 120 and 130 may generate AI-based continuous network configuration updates to be transmitted to and translated by SDN controller 102, which may push the updates to one or more network nodes in SDN network 110 through southbound API 104 to implement an AI optimized network strategy.

In some embodiments, upon determining the network impact associated with the received information, event processor 122 can be configured to determine whether SDN controller 102 is to be commanded to reconfigure SDN network 110. In some embodiments, if the network impact falls below a threshold impact level, event processor 122 can be configured to ignore the event. In contrast, if the network impact falls exceeds or meets the threshold impact level, event processor 122 can be configured to select a user-configured policy based on network-configurations (NC) map database 128 to reconfigure the network configuration of SDN network 110.

In some embodiments, NC map database 128 is configured to store a plurality of network-configuration maps that SDN controller 102 is capable of pushing onto the plurality of network nodes in SDN network 110. In some embodiments, each network configuration map may specify a number of links at each network node, one or more properties of each of the links, which two network nodes are connected by a link, one or more network nodes to exclude from the network, or a combination thereof. In some embodiments, the network-configuration maps can be generated using Path Computation Element Communication Protocol (PCEP). In these embodiments, a Path Computation Element (PCE) can set the various parameters and network traffic flows specified in each network-configuration map for SDN network 110. The PCE may be a separate server coupled to SDN network 110 or be implemented within SDN controller 102.

In some embodiments, to determine a network configuration of SDN network 110 to remedy the event included in the received information, event processor 122 can be configured to receive a plurality of network-configuration maps from NC map database 128. In some embodiments, each network-configuration map includes a network configuration for network nodes associated with a geographical area associated with the geographical indicator in the received information. For example, event processor 122 may query NC map database 128 for one or more network-configuration maps that includes network configurations for network nodes physically located in the geographical area.

In some embodiments, to determine a policy to be applied to SDN network 110, event processor 122 can be configured to select a network-configuration map from the plurality of received network-configuration maps based on the network impact and the geographical area. In some embodiments, event processor 122 can correlate the network impact and the associated geographical area with the plurality of received network-configuration maps to select the network-configuration map. In some embodiments, event processor 122 selects the network-configuration map having the largest negative correlation with respect to the network impact at the geographical area. In some embodiments, event processor 122 can be configured to select the network-configuration map having the highest network performance after including the effects of the network impacts. In particular, event processor 122 may calculate a network performance for each network-configuration map based on one or more of bandwidth thresholds, latency, packet loss, among other metrics monitored by or computed by SDN controller 102. Accordingly, by causing SDN controller 102 to apply the network configuration as indicated in the selected network-configuration map onto SDN network 110, the negative network impact of the event may be neutralized or reduced.

In some embodiments, command generator 124 can be configured to generate a command based on the selected network-configuration map. The, command generator 124 can be configured to transmit the command to SDN controller 102 to reconfigure one or more of the network nodes of SDN network 110 based on the selected network-configuration map. In some embodiments, the command is configured to be receivable and executable via northbound API 103 of SDN controller 102. For example, command generator 124 may be configured to convert the network configurations of the selected network-configuration map into one or more messages that comport with the allowable message types as defined by northbound API 103.

In some embodiments, user interface 121 provides a web-based interface to enable a user to configure one or more of event information stored in events database 126 and network configuration maps stored in NC map database 128. In some embodiments, user interface 121 provides the user with a network architecture of SDN network 110. Based on this information, user interface 121 can enable the user to configure one or more network configuration maps that include respective network configurations for responding to specific events.

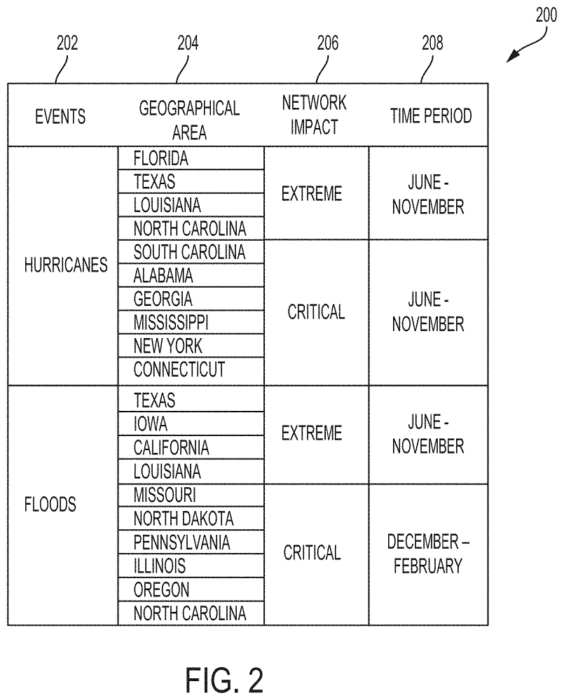

FIG. 2 illustrates example data associations 200 stored in a historical-events database, such as events database 126 of FIG. 1, used to respond to external events, according to some embodiments. As shown in FIG. 2, data associations 200 may be related to weather information. In some embodiments, events 202 related to weather may include one or more of the following: high winds, a wildfire, a thunderstorm, a hurricane (as shown in FIG. 2), a tornado, a flood (as shown in FIG. 2), a cyclone, a waterspout, a blizzard, an ice storm, a dust storm, and the like.

In some embodiments, data associations 200 may associate network impact 206 with a specific combination of events 202, geographical area 204, and time period 208. For example, a hurricane (e.g., event 202) that is forecasted to occur in Florida (e.g., geographical area 204) during a week in July (e.g., time period 208) is associated with extreme impact (e.g., network impact 206). In contrast, the same hurricane forecasted to occur in, for example, Alabama, during that same week in July may only have critical impact.

In some embodiments, to derive network impact 206 for specific combinations of events 202, geographical area 204, and time period 208, a network-control application (e.g., network-control application 120 of FIG. 1) can be configured to analyze historical events data and historical network bandwidth utilization data for network nodes in SDN network 110. For example, based on the received historical data, the network-control application may calculate inbound, outbound, and average bandwidth for network nodes at specific geographical areas 204 to determine network impact 206 in response to a specific event 202.

In some embodiments, as discussed above, the network-control application can implement an Artificial Intelligence (AI) analytics engine to analyze data such as weather data received from external data sources. In some embodiments, the AI analytics engine can be configured to collect and track more detailed information on weather events (e.g., geographic coordinates of new weather events, specific network impacts (physical damage, traffic flows) associated with the new weather events, effects of applied policies in response to new weather events). In some embodiments, the AI analytics engine can dynamically increase the granularity of the Geographical Area 204 characterization (e.g., to the county level), the granularity of the Network Impact 206 characterization (e.g., Extreme for wireless infrastructure), and the granularity of the Time Period characterization (e.g., June-July, August-September, October-November) based on updated data. In some embodiments, this refinement results in more precise characterizations of the historical record in events database 126 and NC map database 128, as described above with respect to FIG. 1.

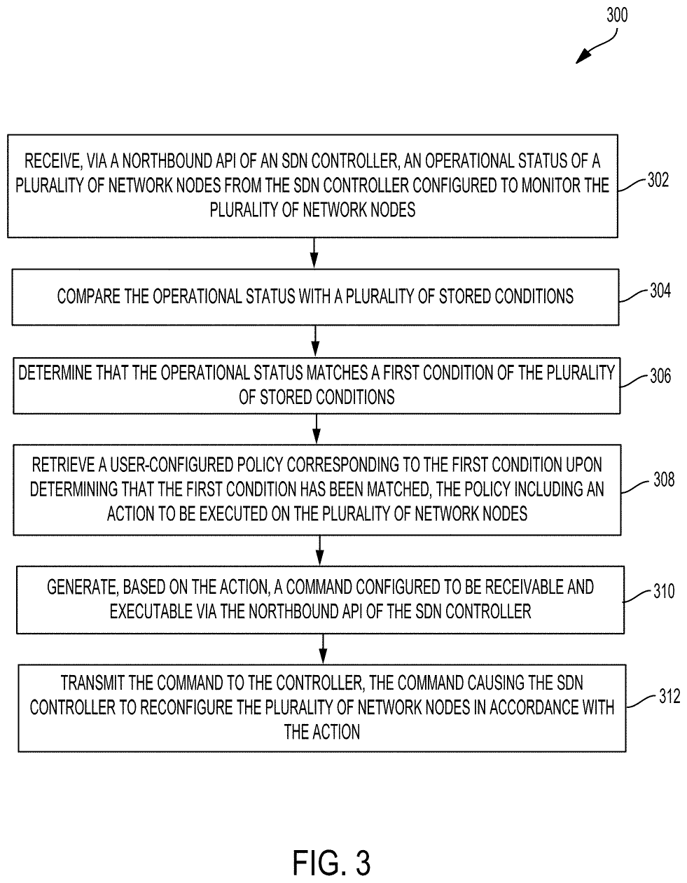

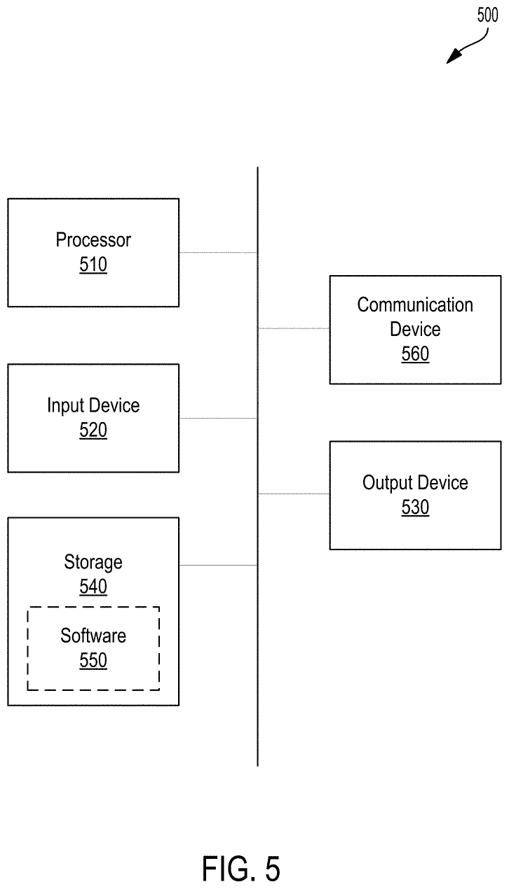

FIG. 3 illustrates a method 300 for dynamically reconfiguring a plurality of network nodes, according to some embodiments. Method 300 can be performed by a network-control application such as network-control application 130, as described with respect to FIG. 1. Accordingly, one or more of the steps below may reference the components of network-control application 130. Method 300 can be performed by a computing system with one or more processors and a memory (e.g., the computer 500 illustrated in FIG. 5). Method 300 may be included in one or more programs stored in the memory that, when executed by the one or more processors, cause the one or more processors to perform method 300.

In step 302, a status processor (e.g., status processor 132) of the network-control application receives, via a northbound application program interface (NB API) of a Software Defined Networking (SDN) controller, an operational status of a plurality of network nodes from the SDN controller. In some embodiments, the SDN controller can be configured to monitor the plurality of network nodes. In some embodiments, the plurality of nodes can be configured within an SDN network such as SDN network 110, as described with respect to FIG. 1.

In step 304, the status processor compares the operational status with a plurality of stored conditions. In some embodiments, the plurality of stored conditions can be stored in a policy database such as policy database 136, as described with respect to FIG. 1.

In step 306, the status processor determines that the operational status matches a first condition of the plurality of stored conditions.

In step 308, the status processor retrieves a user-configured policy corresponding to the first condition upon determining that the first condition has been matched. In some embodiments, the user-configured policy includes an action to be executed on the plurality of network nodes. In some embodiments, the status processor queries the policy database based on the first condition to retrieve the user-configured policy.

In step 310, a command generator (e.g., command generator 134) of the network-control application generates, based on the action, a command configured to be receivable and executable via the NB API of the SDN controller.

In step 312, the command generator transmits the command to the SDN controller. In some embodiments, the command causes the SDN controller to reconfigure the plurality of network nodes in accordance with the action.

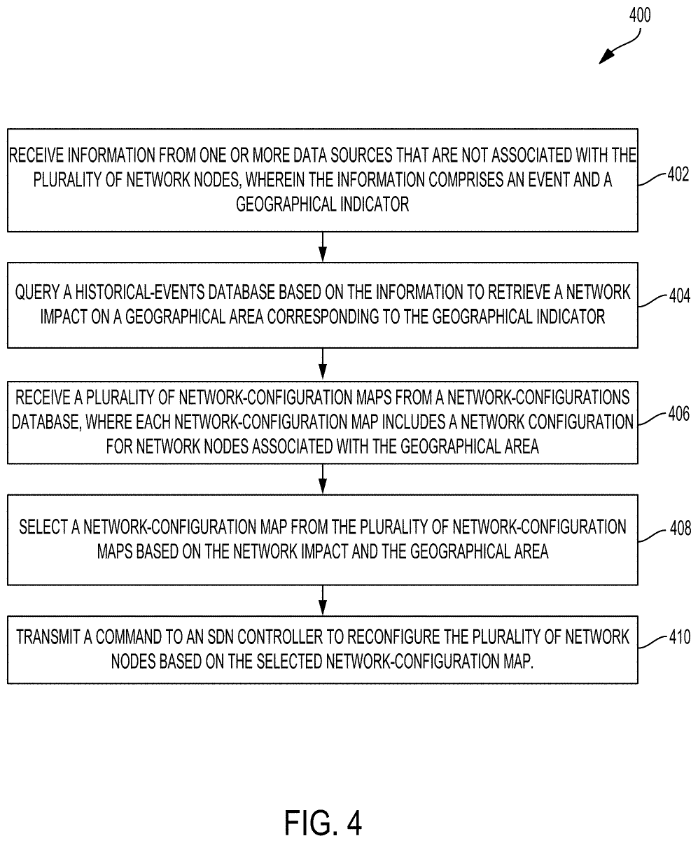

FIG. 4 illustrates a method 400 for dynamically reconfiguring a plurality of network nodes, according to some embodiments. Method 400 can be performed by a network-control application such as network-control application 120, as described with respect to FIG. 1. Accordingly, one or more of the steps below may reference the components of network-control application 120. Method 400 can be performed by a computing system with one or more processors and a memory (e.g., the computer 500 illustrated in FIG. 5). Method 400 may be included in one or more programs stored in the memory that, when executed by the one or more processors, cause the one or more processors to perform method 400.

In step 402, an event processor (e.g., event processor 122) of the network-control application receives information from one or more data sources that are not associated with the plurality of network nodes. In some embodiments, the information includes an event and a geographical indicator. For example, the event may be a weather alert.

In step 404, the event processor queries a historical-events database, such as events database 126, based on the information to retrieve a network impact on a geographical area corresponding to the geographical indicator.

In step 406, the event processor receives a plurality of network-configuration maps from a network-configurations database such as NC map database 128. In some embodiments, each of the network-configuration maps includes a network configuration for network nodes associated with the geographical area.

In step 408, the event processor selects a network-configuration map from the plurality of network-configuration maps based on the network impact and the geographical area. In some embodiments, the event processor performs correlation of the network impact and the geographical area with each network-configuration map to select the network-configuration map. For example, as compared to the other network-configuration maps, the selected network-configuration map may allocate a small number of network links for the network nodes in the geographical area. Therefore, by reconfiguration the SDN network according to the selected network-configuration map, the bandwidth impact that the event may have on the plurality of network nodes in the SDN network may be mitigated.

In step 410, a command generator (e.g., command generator 124) of the network-control application transmits a command to an SDN controller to reconfigure the plurality of network nodes based on the selected network-configuration map. In some embodiments, the command generator is configured to generate the command in a format that comports with the northbound API of the SDN controller.

FIG. 5 illustrates an example of a computer in accordance with one embodiment. Computer 500 can be a component of a system for dynamically reconfiguring a plurality of network nodes, such as system 100 of FIG. 1, or can include the entire system itself. In some embodiments, computer 500 is configured to execute a method for dynamically reconfiguring a plurality of network nodes, such as methods 300 and 400 of FIGS. 3 and 4, respectively.

Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein, such as methods 300 and 400 of FIGS. 3 and 4, respectively.

Software 550, which can be stored in storage 540 and executed by processor 510, can include, for example, the programming that embodies the functionality of the present disclosure (e.g., as embodied in the systems, computers, servers, and/or devices as described above). In some embodiments, software 550 can include a combination of servers such as application servers and database servers.

Software 550 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, optical fiber, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The preceding description sets forth exemplary methods, parameters and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

Although the preceding description uses terms first, second, etc. to describe various elements, these elements should not be limited by the terms. These terms are only used to distinguish one element from another.

Also, it is also to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In some embodiments, a non-transitory computer-readable storage medium stores one or more programs configured to be executed by one or more processors of an electronic device with a display, the one or more programs including instructions for implementing any of the steps described or claimed herein. The present disclosure also relates to a device for performing the operations herein. This device may be specially constructed for the required purposes, or it may include a general-purpose computer selectively activated or reconfigured by a computer program stored in the computer. Such a computer program may be stored in a non-transitory, computer computer-readable storage medium, such as, but not limited to, any type of disk, including floppy disks, optical disks, CD-ROMs, magnetic-optical disks, read-only memories (ROMs), random access memories (RAMs), electrically program read-only memories (EPROMs), electronically erasable program read-only memories EEPROMs, magnetic or optical cards, application specific integrated circuits (ASICs), or any type of media suitable for storing electronic instructions, and each coupled to a computer system bus. Furthermore, the computers referenced in this disclosure may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems appears from the description above. Also, the present disclosure is not described with reference to any particular programming language. It will be appreciated that a variety of programming languages may be used to implement the teachings of the present disclosure as described herein.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A method of dynamically reconfiguring a plurality of network nodes, comprising:
receiving, at an application, via a northbound application program interface (API) of a Software Defined Networking (SDN) controller, an operational status of the plurality of network nodes from the SDN controller configured to monitor the plurality of network nodes;
comparing the operational status with a plurality of stored conditions;
determining that the operational status matches a first condition of the plurality of stored conditions;
retrieving a user-configured policy corresponding to the first condition upon determining that the first condition has been matched, wherein the user-configured policy comprises an action to be executed on the plurality of network nodes;
generating, based on the action, a command configured to be receivable and executable via the northbound API of the SDN controller; and
transmitting the command to the SDN controller, wherein the command causes the SDN controller to reconfigure the plurality of network nodes in accordance with the action.

2. The method of claim 1, wherein to reconfigure the plurality of network nodes, the SDN controller is configured to transmit a plurality of requests to the plurality of network nodes, and wherein the plurality of requests corresponds to the user-configured policy and comports with a southbound API of the SDN.

3. The method of claim 1, wherein the operational status is received in a format that comports with the northbound API of the SDN controller.

4. The method of claim 1, wherein receiving the network status comprises:
requesting the SDN controller to poll the plurality of network nodes for the network status at a user-configurable time interval.

5. The method of claim 1, wherein the operational status comprises a traffic flow path bandwidth for a network node of the plurality of network nodes, a number of traffic flow paths at the network node, a traffic flow bandwidth percentage spike at the network node, a security alert corresponding to the network node, or a response time of the network node.

6. The method of claim 1, wherein the plurality of stored conditions are set by a user.

7. The method of claim 1, further comprising:
receiving a default network status of the plurality of network nodes, wherein one or more of the plurality of conditions corresponds to the default network status.

8. The method of claim 1, wherein the user-configured policy comprises instructions for:
adjusting a bandwidth of one or more traffic flow paths of a network node of the plurality of network nodes.

9. The method of claim 1, wherein the user-configured policy comprises instructions for:
deleting one or more traffic flow paths of a network node of the plurality of network nodes.

10. The method of claim 1, wherein the user-configured policy comprises instructions for:
requesting the SDN controller to dynamically compute an alternate traffic flow path corresponding to a traffic flow path at a network node of the plurality of network nodes.

11. The method of claim 1, wherein the user-configured policy comprises instructions for:
requesting the SDN controller to re-route network traffic to avoid a network node of the plurality of network nodes.

12. The method of claim 1, wherein the user-configured policy comprises instructions for:
reconfiguring a management IP or a host name of a network node of the plurality of network nodes.

13. The method of claim 1, wherein the user-configured policy comprises instructions for:
reconfiguring the plurality of network nodes according to a recovery state comprising a default network configuration.

14. The method of claim 1, wherein the user-configured policy comprises instructions for:
disabling one or more ports of a network node of the plurality of network nodes.

15. The method of claim 1, further comprising:
receiving a second network status from a remote server; and
comparing the second network status with the plurality of stored conditions to determine whether the second network status matches the first condition of the plurality of stored conditions.

16. A system for dynamically reconfiguring a plurality of network nodes, comprising one or more processors and memory storing one or more programs that when executed by the one or more processors cause the one or more processors to:
receive, at an application, via a northbound application program interface (API) of a Software Defined Networking (SDN) controller, an operational status of the plurality of network nodes from the SDN controller configured to monitor the plurality of network nodes;
compare the operational status with a plurality of stored conditions;
determine that the operational status matches a first condition of the plurality of stored conditions;
retrieve a user-configured policy corresponding to the first condition upon determining that the first condition has been matched, wherein the user-configured policy comprises an action to be executed on the plurality of network nodes;
generate, based on the action, a command configured to be receivable and executable via the northbound API of the SDN controller; and
transmit the command to the SDN controller, wherein the command causes the SDN controller to reconfigure the plurality of network nodes in accordance with the action.

17. A non-transitory computer-readable storage medium comprising instructions for dynamically reconfiguring a plurality of network nodes, wherein the instructions, when executed by one or more processors, cause the one or more processors to perform instructions comprising:
receiving, at an application, via a northbound application program interface (API) of a Software Defined Networking (SDN) controller, an operational status of the plurality of network nodes from the SDN controller configured to monitor the plurality of network nodes;
comparing the operational status with a plurality of stored conditions;
determining that the operational status matches a first condition of the plurality of stored conditions;
retrieving a user-configured policy corresponding to the first condition upon determining that the first condition has been matched, wherein the user-configured policy comprises an action to be executed on the plurality of network nodes;
generating, based on the action, a command configured to be receivable and executable via the northbound API of the SDN controller; and
transmitting the command to the SDN controller, wherein the command causes the SDN controller to reconfigure the plurality of network nodes in accordance with the action.
